(19) United States
(12) Patent Application Publication
(10) Pub. No.: US 2026/0102750 A1
(43) Pub. Date: Apr. 16, 2026

(54) INTERNAL MIXER

(71) Applicant: KABUSHIKI KAISHA KOBE SEIKO SHO (KOBE STEEL, LTD.), Hyogo (JP)

(72) Inventors: Hodaka MIURA, Takasago-shi (JP); Martin C. GREEN, Billerica, MA (US); Quentin HARTLEY, Hudson, OH (US)

(73) Assignee: KABUSHIKI KAISHA KOBE SEIKO SHO (KOBE STEEL, LTD.), Hyogo (JP)

(21) Appl. No.: 19/350,607

(22) Filed: Oct. 6, 2025

Related U.S. Application Data
(60) Provisional application No. 63/707,496, filed on Oct. 15, 2024.

(51) Int. Cl. B01F 35/71; B01F 27/42; B01F 27/60; B01F 35/00; B01F 101/00

(52) U.S. Cl. CPC B01F 35/7174; B01F 27/421; B01F 27/60; B01F 35/189; B01F 35/71731; B01F 2101/2805

(57) ABSTRACT

An internal mixer includes a mixing chamber having a mixing room, a material input portion having an inner space, a hopper provided in the material input portion, an exhaust passage having an exhaust port provided in the material input portion, and a driving device that raises and lowers a weight. The driving device can stop the weight at a lower position where the weight having entered the upper opening of the mixing room can press the material to be kneaded from above and an exhaust adjustment position where the weight closes a part of the exhaust port. When the weight is at the lower position, a gap is formed between the weight and the peripheral edge of the mixing chamber defining the upper opening.

### FIELD OF INVENTION

The present invention relates to an internal mixer.

### BACKGROUND ART

Conventionally, as disclosed in Japanese Patent Application Laid-Open No. 2013-107025, Japanese Patent Application Laid-Open No. 2007-118387, and Japanese Patent Application Laid-Open No. Hei 4-16223, there has been known an internal mixer including a mixing chamber having a mixing room, a material input portion located above the mixing chamber, and a weight disposed in the material input portion so as to be movable up and down to the mixing room of the mixing chamber. In this type of mixer, the material to be kneaded is kneaded while a material to be kneaded is pressed from above by the weight in the mixing room.

A kneader disclosed in Japanese Patent Application Laid-Open No. 2013-107025 is used in a kneading method in which a kneading material such as rubber or plastic and a powder blending agent are put together in a mixing room to knead a material to be kneaded. In this kneader, a feeding door, a powder chute, and a ventilation chute are connected to a material input portion located above the mixing chamber. The feeding door is configured to be openable and closable to feed the material to be kneaded. The powder chute is used when the powder blending agent for kneading is supplied. An airbag having a filter body is built in the ventilation chute. By providing the ventilation chute, the dust-containing gas accompanied with the powder blending agent can be prevented from scattering to the outside.

In the kneader disclosed in Japanese Patent Application Laid-Open No. 2007-118387, a hopper door, a gas supply apparatus, and a dust collecting duct are provided in a material input portion. The hopper door is opened when the material to be kneaded is put in. The gas supply apparatus is configured to be able to supply an inert gas into the material input portion. The dust collecting duct is provided with a dust collector. By introducing the inert gas into the mixing room by the gas supply apparatus, dust is collected by the dust collector through the dust collecting duct. Therefore, the particulate concentration in the mixing room can be reduced.

The kneader disclosed in Japanese Patent Application Laid-Open No. Hei 4-16223 is provided with a cylinder further extending upward from a material input portion provided with a hopper door. The weight is configured to rise from the material input portion into the cylinder. The space in the cylinder above the weight is a back pressure chamber, and the cylinder is provided with a dust collector that collects dust contained in the pressurized air in the back pressure chamber.

In the internal mixer disclosed in Japanese Patent Application Laid-Open No. 2013-107025, since the ventilation chute is provided in the material input portion, the dust-containing gas accompanied with the powder blending agent stirred up in the material input portion can be collected by the ventilation chute. However, due to the suction force by the ventilation chute, a part of the kneading powder blending agent supplied through the powder chute may be suctioned by the ventilation chute. In the internal mixer disclosed in Japanese Patent Application Laid-Open No. 2007-118387, the powder additive fed into the material input portion may be suctioned into the dust collecting duct. The dust collector disclosed in Japanese Patent Application Laid-Open No. Hei 4-16223 includes a dust collector that collects dust contained in pressurized air in the back pressure chamber. However, the hopper frame provided with the hopper door is not provided with a chute or the like for sucking gas.

Further, none of Japanese Patent Application Laid-Open No. 2013-107025, Japanese Patent Application Laid-Open No. 2007-118387, and Japanese Patent Application Laid-Open No. Hei 4-16223 suggests a measure against a case where the internal pressure in the mixing room can be increased by steam generated from the material to be kneaded during kneading of the material to be kneaded.

### SUMMARY OF THE INVENTION

An object of the present invention is to provide an internal mixer capable of suppressing an increase in internal pressure in a mixing room during kneading and suppressing discharge of a powdery material contained in a material to be kneaded fed to a material input portion.

A internal mixer according to an aspect of the present invention includes: a mixing chamber having a mixing room having an upper opening; a material input portion located above the mixing chamber and having an inner space communicating with the mixing room; an openable and closable hopper provided on one lateral wall of the material input portion and configured to be able to introduce a material of a material to be kneaded into the inner space of the material input portion; an exhaust passage connected to another lateral wall so as to communicate with the inner space through an exhaust port formed on the another lateral wall of the material input portion; a weight provided in the inner space; a driving device configured to generate a driving force for raising and lowering the weight and to be able to stop the weight at a lower position and at an exhaust adjustment position, the lower position being a position where the weight enters an upper opening of the mixing room while the weight is able to press the material to be kneaded in the mixing room from above, and the exhaust adjustment position being located above the lower position and closing at least the exhaust port by the weight; and a pair of mixing rotor configured to knead the material to be kneaded in the mixing room. The weight has a shape that forms a gap between the weight and a peripheral edge defining the upper opening of the mixing room so that a gas generated from the material to be kneaded can be discharged from the mixing room to the inner space when the weight is at the lower position.

### BRIEF DESCRIPTION OF THE DRAWINGS

FIG. 1 is a cross-sectional view illustrating an internal mixer according to the present embodiment in which a weight is at an exhaust adjustment position and a hopper is in an open state.

FIG. 2 is a cross-sectional view illustrating the internal mixer according to the present embodiment in which the weight is at a lower position and the hopper is in a closed state.

FIG. 3 is a cross-sectional view illustrating the internal mixer according to the present embodiment in which the weight is at the exhaust adjustment position and the hopper is in the closed state.

FIG. 4 is a diagram for explaining a recess provided on a side surface of a weight.

FIG. 5 is a diagram for explaining a configuration of an upper surface of a weight.

FIG. 6 is a cross-sectional view illustrating a internal mixer according to a modification.

FIG. 7 is a diagram for explaining an opening for taking outside air into an inner space.

FIG. 8 is a diagram for explaining an introduction port for introducing compressed air into the inner space.

### DETAILED DESCRIPTION

In the following, embodiments of the present invention will be described in detail with reference to the drawings.

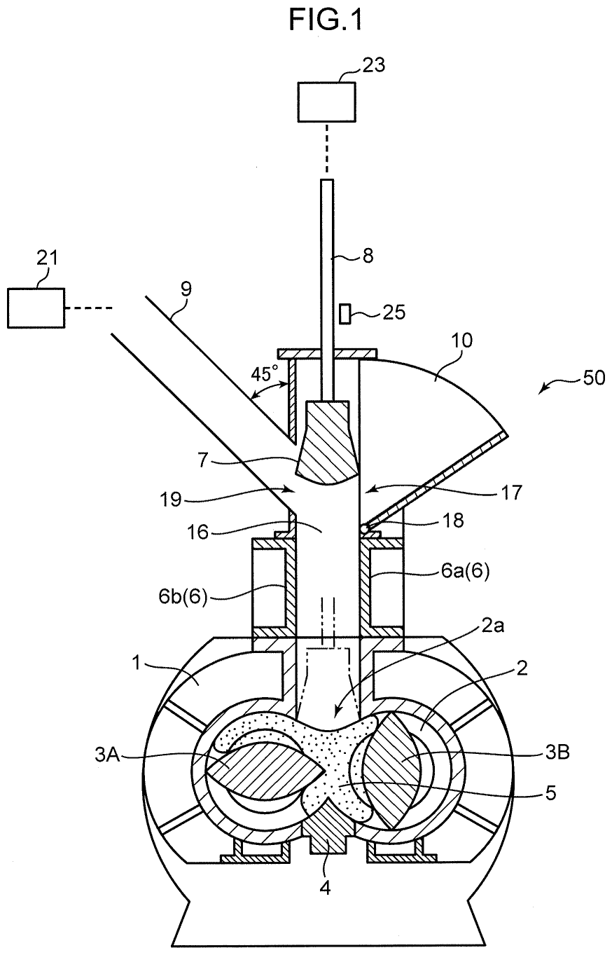

As illustrated in FIG. 1, an internal mixer 50 according to the present embodiment is a device for kneading a material to be kneaded 5 such as rubber or resin, and includes a mixing chamber 1 having a mixing room 2 with an open upper portion, and a material input portion 6 located above the mixing chamber 1. That is, the mixing room 2 has an upper opening 2a.

The mixing room 2 is a room for kneading the material to be kneaded 5, and a pair of mixing rotor 3A and 3B is disposed in the mixing room 2. The pair of mixing rotor 3A and 3B is disposed in parallel with each other and rotatable in the mixing room 2. Each of the mixing rotor 3A and 3B is driven and rotated by a motor (not illustrated) disposed outside the mixing chamber 1. The pair of mixing rotor 3A and 3B are driven to knead the material to be kneaded 5 in the mixing room 2.

A discharge port 4 for discharging the material to be kneaded 5 which has been kneaded is provided in a lower portion of the mixing chamber 1. The discharge port 4 is closed when the material to be kneaded 5 is kneaded, and is opened by a discharge command.

The material input portion 6 is formed in a cylindrical shape having a rectangular cross section. That is, the material input portion 6 includes a pair of lateral walls facing each other in one direction and another pair of lateral walls facing each other in a direction orthogonal to the one direction. The material input portion 6 is hollow, and the inner space 16 of the material input portion 6 communicates with the mixing room 2 through the upper opening 2a.

The material input portion 6 is provided with a hopper 10 for feeding the material of the material to be kneaded 5 into an inner space 16, and an exhaust passage 9 for discharging a gas such as steam discharged from the mixing room 2.

The hopper 10 is provided on one lateral wall (first lateral wall 6a) of the material input portion 6. The hopper 10 is configured to open and close an opening 17 (or a feeding port) formed in the first lateral wall 6a. That is, the hopper 10 is disposed such that the lower end portion thereof is positioned at the lower edge of the opening 17, and a hinge 18 is provided at the lower end portion of the hopper 10. As a result, the hopper 10 is rotatable about the axis of the hinge 18 located at the lower end portion. When the hopper 10 rotates, the opening 17 is opened and closed. That is, the hopper 10 is an opening/closing type. With an opening 17 opened by the hopper 10, the material of the material to be kneaded 5 can be fed into the inner space 16 of the material input portion 6.

The exhaust passage 9 is connected to a lateral wall (second lateral wall 6b) different from the first lateral wall 6a provided with the hopper 10. That is, an exhaust port 19 is opened in the second lateral wall 6b, and the exhaust passage 9 is connected to the second lateral wall 6b so as to communicate with the inner space 16 through the exhaust port 19. In the present embodiment, the second lateral wall 6b is a lateral wall facing the first lateral wall 6a, but may be a lateral wall adjacent to the first lateral wall 6a.

The exhaust passage 9 extends obliquely upward from the exhaust port 19. For example, the exhaust passage 9 extends in a direction inclined at 40 degrees to 50 degrees with respect to the vertical direction. The lower edge of the exhaust port 19 is set at a position higher than the lower edge of the opening 17 (or the feeding port) of the first lateral wall 6a. Therefore, it is possible to prevent the material fed from the hopper 10 from directly flowing into the exhaust passage 9. Even if the powdery material swirling up in the inner space 16 enters the exhaust passage 9, the material can fall into the mixing room 2, so that the exhaust port 19 can be prevented from being clogged.

A suction machine 21 is provided in the exhaust passage 9. By operating the suction machine 21, the gas (including dust or the like in some cases) in the inner space 16 of the material input portion 6 can be discharged to the outside of the internal mixer 50 through the exhaust passage 9.

A weight 7 is disposed in the inner space 16 of the material input portion 6 so as to be movable up and down. The weight 7 is connected to a driving device 23 for moving up and down the weight 7 via a connecting rod 8.

The driving device 23 generates a driving force for raising and lowering the weight 7. The driving device 23 includes, for example, a cylinder (not illustrated) and a piston (not illustrated) slidably disposed in the cylinder, and may be configured to move the weight 7 in the vertical direction via the connecting rod 8 by reciprocating movement of the piston.

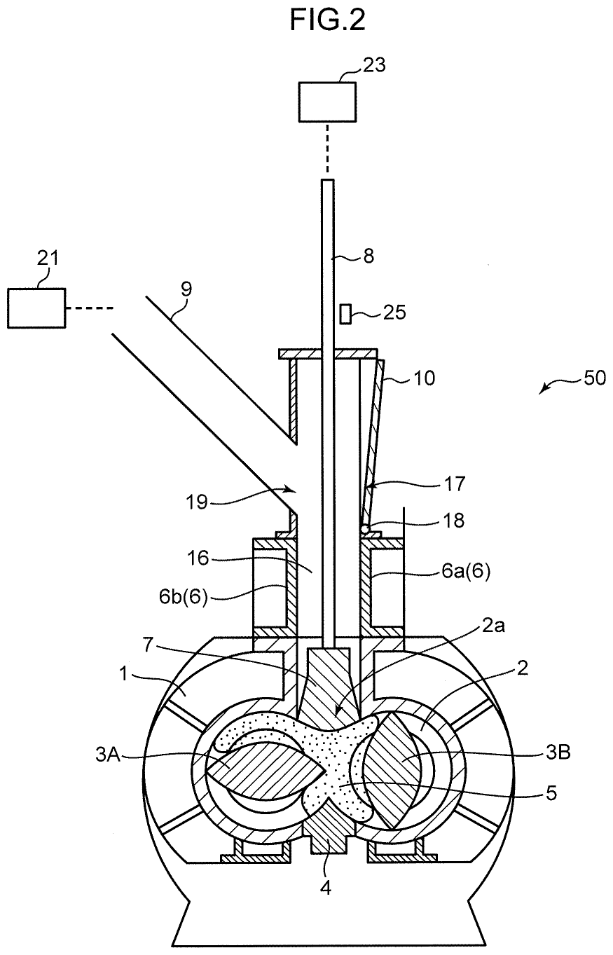

The driving device 23 is configured to be able to stop the weight 7 at a lower position (position illustrated in FIG. 2) and an exhaust adjustment position (position illustrated in FIG. 1). That is, by controlling the working fluid supplied to the cylinder, the weight 7 can be stopped at the lower position and the exhaust adjustment position. In this case, for example, a detector 25 that detects the position of the connecting rod 8 (or the weight 7 or the piston) may be provided, and the driving device 23 may control the stop position of the weight 7 based on the detection result by the detector 25. In addition, a stopper (not illustrated) for stopping the weight 7 at the exhaust adjustment position may be provided, and in this case, the driving device 23 may raise the weight 7 until the weight 7 abuts on the stopper to stop at the exhaust adjustment position. The driving device 23 may be set such that the upper limit of the moving range of the weight 7 is at the exhaust adjustment position and the lower limit of the moving range is at the lower position.

As illustrated in FIG. 2, when the weight 7 is at the lower position, the weight 7 enters the upper opening 2a of the mixing room 2. The weight 7 thus presses the material to be kneaded 5 in the mixing room 2 from above. The driving device 23 applies a downward force to the weight 7 so that the weight 7 can press the material to be kneaded 5.

As illustrated in FIG. 1, the exhaust adjustment position is a position where the weight 7 is raised from the lower position. When the weight 7 is at the exhaust adjustment position, the upper opening 2a of the mixing room 2 is opened to the inner space 16 of the material input portion 6. When the weight 7 is at the exhaust adjustment position, substantially half (substantially upper half) of the exhaust port 19 is closed by the weight 7. However, the weight 7 at the exhaust adjustment position is not limited to the position that blocks substantially half of the exhaust port 19, and may be any position as long as it blocks at least a part of the exhaust port 19.

The exhaust adjustment position is also the position of the weight 7 when the opening 17 is opened by the hopper 10 to feed the material. Therefore, it is possible to suppress the material fed from the hopper 10 to unintentionally flow into the exhaust passage 9 through the exhaust port 19.

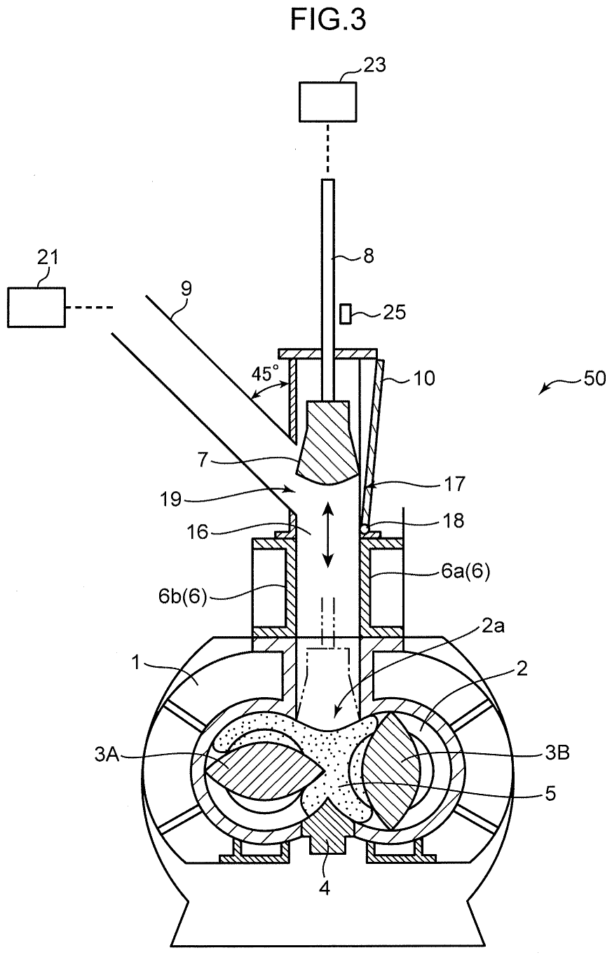

As illustrated in FIG. 3, the driving device 23 may position the weight 7 at the exhaust adjustment position when the hopper 10 is closed and the material to be kneaded 5 is kneaded in the mixing room 2. That is, in a case where it is not necessary to perform kneading while pressing the material to be kneaded 5 with the weight 7 depending on the kneading condition, the driving device 23 may position the weight 7 at the exhaust adjustment position. Even in this case, the weight 7 blocks a part of the exhaust port 19, so that the powdery material scattered from the material to be kneaded 5 is prevented from flowing into the exhaust passage 9.

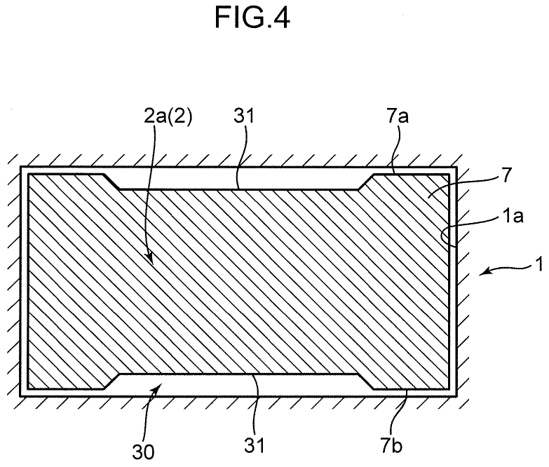

When the weight 7 is at the lower position, the upper opening 2a of the mixing room 2 is substantially closed by the weight 7. At this time, as illustrated in FIG. 4, a gap 30 is formed between the peripheral edge 1a (or the inner peripheral surface) defining the upper opening 2a in the mixing chamber 1 and the side surface of the weight 7 located at the lower position. Therefore, in a case where the internal pressure of the mixing room 2 increases, the air (in some cases, a fed powdery material, a gas generated from the material to be kneaded 5, and the like are also included) in the mixing room 2 may leak into the inner space 16 of the material input portion 6 through the gap 30.

Further, a recess 31 is formed on the side surface of the weight 7, and the size of the gap 30 is enlarged by forming the recess 31. That is, the gap 30 is formed between the side surface of the weight 7 and the peripheral edge 1a (or the inner peripheral surface) defining the upper opening 2a without forming the recess 31 on the side surface of the weight 7, and the width of the gap 30 is larger due to the presence of the recess 31.

As illustrated in FIG. 4, the recess 31 is provided on a pair of side surfaces 7a and 7b facing opposite to each other. However, the present embodiment is not limited to this configuration. The recess 31 may be provided on at least one side surface, and may be provided on each of all side surfaces of the weight 7.

The recess 31 may be provided on the side surface 7a facing the second lateral wall 6b provided with the exhaust port 19 in the material input portion 6 among the side surfaces of the weight 7. In this case, a gas flowing upward through the gap 30 between the peripheral edge 1a (or the inner peripheral surface) of the upper opening 2a and the recess 31 directly flows into the exhaust passage 9 through the exhaust port 19. Therefore, in a case where the powdery material of the gas is contained, the powdery material is easily suctioned into the exhaust passage 9.

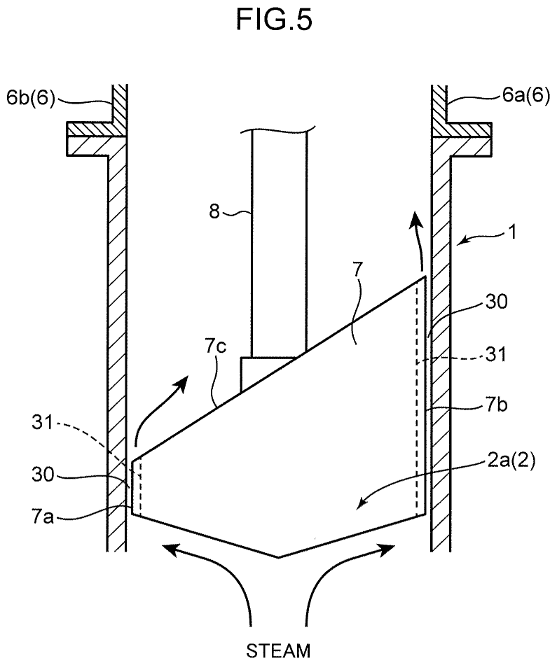

As illustrated in FIG. 5, an upper surface 7c of the weight 7 is inclined. Specifically, the upper surface 7c of the weight 7 is inclined such that the exhaust port 19 side is lower than the hopper 10 side. That is, the height of the side surface 7a of the weight 7 facing the second lateral wall 6b is lower than the height of a side surface 7b of the weight 7 facing the first lateral wall 6a. Thus, a gas such as steam generated in the mixing room 2 easily passes through the gap 30 closer to the exhaust port 19 side than the gap 30 closer to the hopper 10 side. In addition, in a case where the recess 31 is provided in the side surface 7a of the weight 7 facing the second lateral wall 6b provided with the exhaust port 19, a gas such as steam can more easily flow in the gap 30 on the exhaust port 19 side. In addition, since the upper surface 7c of the weight 7 is inclined, it is possible to prevent the powder component from being accumulated on the upper surface 7c of the weight 7.

In the internal mixer 50 of the present embodiment having the configuration described above, the material to be kneaded 5 is fed into the mixing chamber 1 from the material input portion 6 with the weight 7 at the exhaust adjustment position. After the material to be kneaded 5 is fed, the driving device 23 lowers the weight 7 to the lower position. When the weight 7 reaches the lower position where the weight 7 enters the upper opening 2a of the mixing room 2, the driving device 23 stops lowering the weight 7. At this time, the gap 30 is formed between the peripheral edge 1a of the upper opening 2a in the mixing chamber 1 and the side surface of the weight 7. When the pair of mixing rotor 3A and 3B is driven in this state, the material to be kneaded 5 is kneaded in the mixing room 2.

At the time of kneading, moisture and the like contained in the material to be kneaded 5 may vaporize to generate steam as the temperature of the material to be kneaded 5 rises. This vapor may flow out into the inner space 16 of the material input portion 6 through the gap 30. Therefore, even when the material to be kneaded 5 that generates a large amount of steam is kneaded, an increase in the internal pressure of the mixing room 2 can be suppressed. The gas flowing into the inner space 16 is suctioned into the exhaust passage 9 through the exhaust port 19 by the operation of the suction machine 21 and discharged to the outside of the internal mixer 50. In a case where the gap 30 is clogged for some reason, a foreign substance can be scraped by a scraper (not illustrated) or the like after the weight 7 is raised.

On the other hand, when the driving device 23 operates to raise the weight 7 from the lower position, the driving device 23 stops the weight 7 at the exhaust adjustment position. In this state, the hopper 10 is opened, and the material (material to be kneaded 5, additives, etc.) of the material to be kneaded 5 can be fed into the inner space 16 of the material input portion 6. At this time, the suction machine 21 is in a stopped state, and at least a part of the exhaust port 19 is blocked by the weight 7. Thus, in a case where the material to be kneaded 5 fed from the hopper 10 contains a powdery material, even if the powdery material blows up, the powdery material can be prevented from flowing into the exhaust passage 9 through the exhaust port 19. Therefore, it is possible to prevent the powdery material from being discharged to the outside of the internal mixer 50.

When the weight 7 is at the exhaust adjustment position, substantially half of the exhaust port 19 is blocked by the weight 7. Therefore, since the exhaust port 19 can be substantially closed while preventing the movement stroke of the weight 7 from becoming excessive, the overall height of the internal mixer 50 can be suppressed while obtaining a configuration in which a part of the exhaust port 19 is closed.

In the present embodiment, the recess 31 is provided on the side surface 7a located immediately below the exhaust port 19 among the side surfaces of the weight 7. Therefore, when the gas generated from the material to be kneaded 5 flows out of the mixing room 2 through the gap 30 between the recess 31 of the weight 7 and the peripheral edge 1a (or the inner peripheral surface) defining the upper opening 2a, the gas rises and is guided to the exhaust port 19 as it is. Therefore, the gas can be efficiently guided to the exhaust passage 9.

In the present embodiment, the upper surface 7c of the weight 7 is inclined such that the portion on the exhaust port 19 side is lower than the portion on the hopper 10 side. Therefore, the thickness of the weight 7 in the height direction is thin on the exhaust port 19 side and thick on the hopper 10 side. Therefore, a gas such as steam can be efficiently guided to the exhaust port 19 on the exhaust port 19 side. In a case where the material of the material to be kneaded 5 contains a powder component, the powder component can be prevented from accumulating on the upper surface 7c of the weight 7.

### Other Embodiments

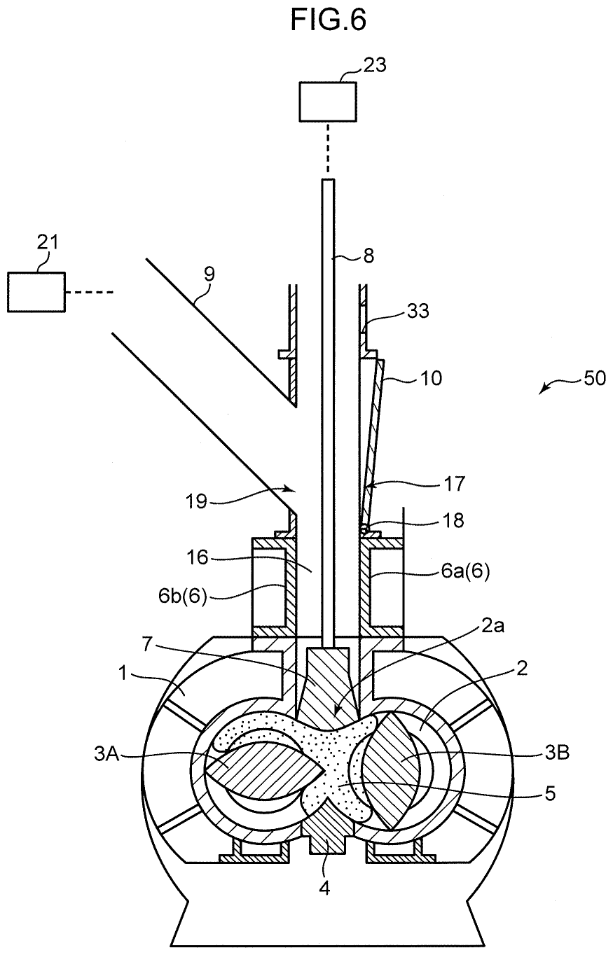

It should be understood that the embodiment disclosed herein is illustrative in all respects and is not restrictive. The present invention is not limited to the above embodiment, and various changes, improvements, and the like can be made without departing from the gist of the present invention. For example, as illustrated in FIG. 6, an opening 33 may be formed in the lateral wall of the material input portion 6 at a position on the upper side of the hopper 10. The opening 33 functions as an intake port for taking outside air into the inner space 16 when the hopper 10 is closed and the suction machine 21 is in operation. When the outside air is taken in through the opening 33, it is possible to prevent gases such as water vapor and ethanol generated from the material to be kneaded 5 from staying in the inner space 16 of the material input portion 6.

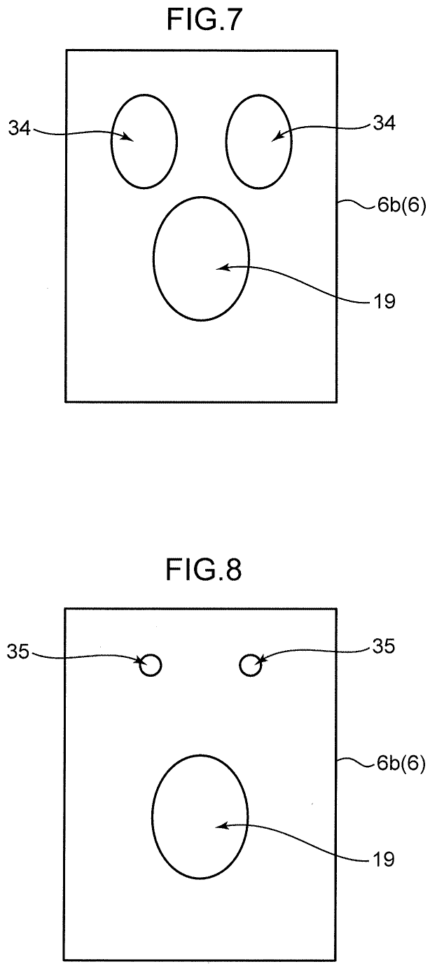

As illustrated in FIG. 7, in the material input portion 6, an opening 34 may be provided in the second lateral wall 6b where the exhaust port 19 is formed. This opening 34 also functions as an intake port for taking outside air into the inner space 16 when the suction machine 21 is in operation. In addition, a plurality of openings 34 may be provided. In addition, the openings 33 and 34 may be provided on any lateral wall of the material input portion 6. Therefore, for example, the opening 33 of the first lateral wall 6a and the opening 34 of the second lateral wall 6b may be provided, or only the opening 34 of the second lateral wall 6b may be provided.

As illustrated in FIG. 8, the material input portion 6 may be provided with an introduction port 35 for compressed air. A pipe (not illustrated) connected to the compressor (not illustrated) is connected to the introduction port 35. The compressed air discharged from the compressor is sent into the inner space 16 of the material input portion 6 through the introduction port 35. Therefore, when the suction machine 21 operates, the compressed air is sent into the inner space 16, so that the gas in the inner space 16 can be more smoothly discharged to the outside through the exhaust passage 9. Therefore, the gas generated from the material to be kneaded 5 can be more effectively prevented from staying, and forced ventilation can be performed. The introduction port 35 may be provided in the second lateral wall 6b where the exhaust port 19 is formed, or may be provided in a lateral wall different from the second lateral wall 6b. Furthermore, the number of the introduction ports 35 may be arbitrary.

In the above embodiment, the recess 31 is provided on the side surface of the weight 7, but the recess 31 may be omitted as long as exhaust through the gap 30 between the side surface of the weight 7 and the peripheral edge 1a (or the inner peripheral surface) of the upper opening 2a is sufficient. However, since the recess 31 is formed, the place where the gas is discharged from the mixing room 2 can be concentrated, so that the exhaust to the exhaust port 19 can be easily controlled. The recess 31 may not be positioned directly below the exhaust port 19.

In the above embodiment, the upper surface 7c of the weight 7 is inclined, but the upper surface 7c of the weight 7 may not be inclined as long as the material of the material to be kneaded 5 does not contain a large amount of powder components.

Here, the embodiments will be outlined.

The internal mixer according to the embodiment includes: a mixing chamber having a mixing room having an upper opening; a material input portion located above the mixing chamber and having an inner space communicating with the mixing room; an openable and closable hopper provided on one lateral wall of the material input portion and configured to be able to introduce a material of a material to be kneaded into the inner space of the material input portion; an exhaust passage connected to another lateral wall so as to communicate with the inner space through an exhaust port formed on the another lateral wall of the material input portion; a weight provided in the inner space; a driving device configured to generate a driving force for raising and lowering the weight and to be able to stop the weight at a lower position and at an exhaust adjustment position, the lower position being a position where the weight enters an upper opening of the mixing room while the weight is able to press the material to be kneaded in the mixing room from above, and the exhaust adjustment position being located above the lower position and closing at least the exhaust port by the weight; and a pair of mixing rotor configured to knead the material to be kneaded in the mixing room. The weight has a shape that forms a gap between the weight and a peripheral edge defining the upper opening of the mixing room so that a gas generated from the material to be kneaded can be discharged from the mixing room to the inner space when the weight is at the lower position.

In the internal mixer, the material to be kneaded is fed from the material input portion into the mixing chamber with the weight at the exhaust adjustment position. After the material to be kneaded is fed, the driving device lowers the weight to the lower position. When the weight reaches the lower position, the driving device stops lowering the weight. At this time, a gap is generated between the weight and the peripheral edge of the mixing chamber that defines the upper opening of the mixing room. When the pair of mixing rotor is driven in this state, the material to be kneaded is kneaded in the mixing room.

At the time of kneading, moisture and the like contained in the material to be kneaded may vaporize to generate steam as the temperature of the material to be kneaded rises. This vapor may flow out into the inner space of the material input portion through the gap. Therefore, even when the material to be kneaded that generates a large amount of steam is kneaded, an increase in the internal pressure of the mixing room can be suppressed.

On the other hand, when the driving device operates to raise the weight from the lower position, the driving device stops the weight at the exhaust adjustment position. In this state, the hopper is opened, and the material to be kneaded can be fed into the inner space of the material input portion. At this time, at least a part of the exhaust port is blocked by the weight. Therefore, in a case where the material to be kneaded fed from the hopper contains the powdery material, even if the powdery material blows up, the powdery material can be prevented from flowing into the exhaust passage. Therefore, it is possible to prevent the powdery material from being discharged to the outside of the internal mixer.

At least a part of the exhaust port when the weight is at the exhaust adjustment position may be substantially a half of the exhaust port.

In this aspect, the exhaust port can be substantially closed while preventing the movement stroke of the weight from becoming excessive. Therefore, it is possible to suppress the overall height of the internal mixer while obtaining a configuration in which a part of the exhaust port is blocked.

A recess may be provided on a side surface of the weight. In this case, a gap between the recess and the peripheral edge of the mixing chamber may be located below the exhaust port.

In this aspect, since the gap width between the side surface of the weight and the peripheral edge of the mixing chamber is enlarged, the gas generated from the material to be kneaded can easily flow out of the mixing room. In addition, the gas flowing out of the mixing room through the gap between the recess and the peripheral edge of the mixing chamber can be guided to the exhaust port as it is only by raising the gas. That is, the position where the gas flows out from the mixing room can be easily controlled.

The another lateral wall of the material input portion provided with the exhaust port and the one lateral wall of the material input portion provided with the hopper may face each other. In this case, the upper surface of the weight may be inclined such that a portion on the exhaust port side is lower than a portion on the hopper side.

In this aspect, the thickness of the weight in the height direction is thin on the exhaust port side and thick on the hopper side. Therefore, a gas such as steam can be efficiently guided to the exhaust port on the exhaust port side. In a case where the material of the material to be kneaded contains a powder component, the powder component can be prevented from accumulating on the upper surface of the weight.

A suction machine may be connected to the exhaust passage, and in this case, the material input portion may be provided with an opening capable of taking outside air into the inner space. In this aspect, the outside air may flow into the inner space of the material input portion through the opening when the suction machine is activated to discharge the gas in the inner space. Therefore, it is possible to smoothly discharge the gas in the inner space.

The material input portion may be provided with an introduction port through which compressed air can be introduced into the inner space. In this aspect, the compressed air can be introduced into the inner space through the introduction port. Therefore, when the suction machine operates, the compressed air is sent into the inner space, so that the gas in the inner space can be more smoothly discharged to the outside through the exhaust passage. In other words, the gas in the inner space can be forcibly replaced with compressed air.

As described above, it is possible to suppress an increase in the internal pressure of the mixing room during kneading, and it is also possible to suppress the discharge of the powdery material contained in the material to be kneaded fed to the material input portion.

This application is based on U.S. Provisional application No. 63/707,496 filed in United States Patent and Trademark Office on Oct. 15, 2024, the contents of which are hereby incorporated by reference.

1. An internal mixer comprising:
a mixing chamber having a mixing room having an upper opening;
a material input portion located above the mixing chamber and having an inner space communicating with the mixing room;
an openable and closable hopper provided on one lateral wall of the material input portion and configured to be able to introduce a material of a material to be kneaded into the inner space of the material input portion;
an exhaust passage connected to another lateral wall so as to communicate with the inner space through an exhaust port formed on the another lateral wall of the material input portion;
a weight provided in the inner space;
a driving device configured to generate a driving force for raising and lowering the weight and to be able to stop the weight at a lower position and at an exhaust adjustment position, the lower position being a position where the weight enters an upper opening of the mixing room while the weight is able to press the material to be kneaded in the mixing room from above, and the exhaust adjustment position being located above the lower position and closing at least the exhaust port by the weight; and
a pair of mixing rotor configured to knead the material to be kneaded in the mixing room,
wherein the weight has a shape that forms a gap between the weight and a peripheral edge defining the upper opening of the mixing room so that gas generated from the material to be kneaded can be discharged from the mixing room to the inner space when the weight is at the lower position.

2. The internal mixer according to claim 1, wherein at least a part of the exhaust port when the weight is at the exhaust adjustment position is substantially a half of the exhaust port.

3. The internal mixer according to claim 1, wherein
a recess is provided on a side surface of the weight, and
a gap between the recess and the peripheral edge of the mixing chamber is located below the exhaust port.

4. The internal mixer according to claim 1, wherein
the another lateral wall of the material input portion provided with the exhaust port and the one lateral wall of the material input portion provided with the hopper face each other, and
an upper surface of the weight is inclined such that a portion on the exhaust port side is lower than a portion on the hopper side.

5. The internal mixer according to claim 1, wherein
a suction machine is connected to the exhaust passage, and
the material input portion is provided with an opening through which outside air can be taken into the inner space.

6. The internal mixer according to claim 5, wherein the material input portion is provided with an introduction port through which compressed air can be introduced into the inner space.
